(19) United States
(12) Patent Application Publication
(10) Pub. No.: US 2020/0106636 A1
(43) Pub. Date: Apr. 2, 2020

(54) System and Method for Extracting Appliance Instructions and Settings from Electronic Recipes and Controlling Connected Appliances

(71) Applicant: Chefling, Inc., Sunnyvale, CA (US)

(72) Inventors: Quan Xie, Sunnyvale, CA (US); Mingzi Yi, Sunnyvale, CA (US); Amar Krishna, San Mateo, CA (US); Nancy Tu, San Jose, CA (US); Anshu Kumar, Bengaluru (IN)

(73) Assignee: Chefling, Inc.

(21) Appl. No.: 16/590,583

(22) Filed: Oct. 2, 2019

Related U.S. Application Data
(60) Provisional application No. 62/740,374, filed on Oct. 2, 2018.

(51) Int. Cl. H04L 12/28; G06F 9/451; G05B 19/042; A47J 36/32; H04L 29/08

(52) U.S. Cl. CPC H04L 12/2816; G06F 9/451; H04L 2012/285; A47J 36/321; H04L 67/12; G05B 19/042

(57) ABSTRACT

The present systems and methods are configured to extract appliance instructions and settings from recipes to control connected appliances using the extracted instructions, wherein the system automates the appliance parameters from recipe instructions.

### CROSS-REFERENCE TO RELATED APPLICATIONS

This application incorporates by reference and claims the benefit of priority to U.S. Provisional Application 62/740,374 filed on Oct. 2, 2018.

### BACKGROUND OF THE INVENTION

The present subject matter relates generally to systems and methods for extracting appliance instructions from digital recipes and manipulating connected kitchen appliances in accordance to the extracted instructions.

According to Statista.com, the penetration of smart appliances in U.S. families is 14% in 2018 and is expected grow to more than 24% in 2022. However, manufacturers have had a hard time convincing more customers to use the connected functionalities that these appliances provide. Most of the customer concerns come from two aspects: lack of compelling use cases, privacy, and complicated software.

People routinely locate recipes on websites or through mobile applications. A recipe usually contains ingredients, as well as step-by-step cooking instructions. These instructions include the parameters, settings, and timer information for certain appliances, such as, “preheat the oven to 350 F,” or “roast the turkey in the oven at 400 F for 1 hour,” etc. The user has needed to read these instructions and manually set the corresponding parameters on the relevant appliance.

Some previously existing smart appliances have been able to execute some level of automation in following electronic recipes. However, the functionality of these smart appliances has been limited in that they have only been capable of executing instructions from recipes formatted for use in a companion application. The recipes in the companion software are specially curated for a singular, specialized appliance, which limits the amount of content available to work with the given appliance and it rules out using recipes not specifically adapted for working with the appliance. Thus, the customers' choices are very limited.

Further, conventional software solutions are preprogrammed with certain instructions, wherein users can initiate the pre-embedded instructions to send to one appliance. However such systems are only compatible with pre-determined and approved recipes, limited to work with only the corresponding appliance, time consuming to load and program the instructions, and there is not an ability to update recipes.

Accordingly, there is a need for systems and methods that more easily and efficiently enable users to use electronic recipes of any format with smart appliances, as described herein.

### BRIEF SUMMARY OF THE INVENTION

To meet the needs described above and others, the present disclosure provides systems and methods for linking electronic recipes with smart appliances more efficiently and easily. More specifically, the present invention relates to systems and methods for extracting appliance instructions and settings from recipes and controlling connected appliances using the instructions, automating the appliance parameters from recipe instructions.

An objective of the present system is to improve the ease and efficiency of using connected appliances through a connected network, which addresses the two biggest complaints from smart appliance customers, lack of use cases and hard to use software.

In an example, the system includes a controller; a memory coupled to the controller, wherein the memory is configured to store program instructions executable by the controller; wherein in response to executing the program instructions, the controller is configured to receive a selected recipe from a user interface associated with a user; extract at least one cooking appliance instruction from the selected recipe, wherein the cooking appliance instruction includes an appliance identifier and an appliance cooking parameter, wherein the appliance cooking parameter including a time duration parameter and a temperature parameter; identify a cooking appliance corresponding to the appliance identifier, wherein the cooking appliance is in communication with the controller; communicate the cooking appliance parameter to the cooking appliance corresponding to the appliance identifier, wherein the controller alters a temperature of the cooking appliance to match the temperature parameter for the time duration parameter; and notify the user upon the cooking appliance achieving the appliance cooking parameter via the user interface.

An advantage of the present invention is that it allows users to control appliances very efficiently, without having to navigate the entire setting interface. At the same time, the “Drawer” style control center lists all appliances in one place, allowing users to view recipes and controlling appliances very efficiently.

Another advantage of the present invention is that it allows any existing recipe to be able to work with connected appliances. It unleashes the limitation of human curation method to generate “machine readable recipes”, so that customers will be able to view their favorite bloggers' recipes in the companion app and use the connected appliance to automate some of the appliance related cooking processes.

The present system provides an algorithm that enables scale up quickly and efficiently. The system does not require complicated configuration for different appliances including different brands of appliances. Moreover, multiple recipe platforms can be used and extracted from to be used with the system, thereby having up to date recipes at all times.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is an example of a flow chart of the present system.

FIG. 2 is a schematic of an example of the interaction of the various modules of the system.

FIGS. 3A-3F are examples of various user interfaces used during the application of the system in communication with appliances.

### DETAILED DESCRIPTION OF THE INVENTION

The present system can include a mobile application or web application that controls smart refrigerators and/or pantries. The mobile application can feature a graphical user interface comprised of a series of graphical user interface “screens” for receiving user action with the screen elements.

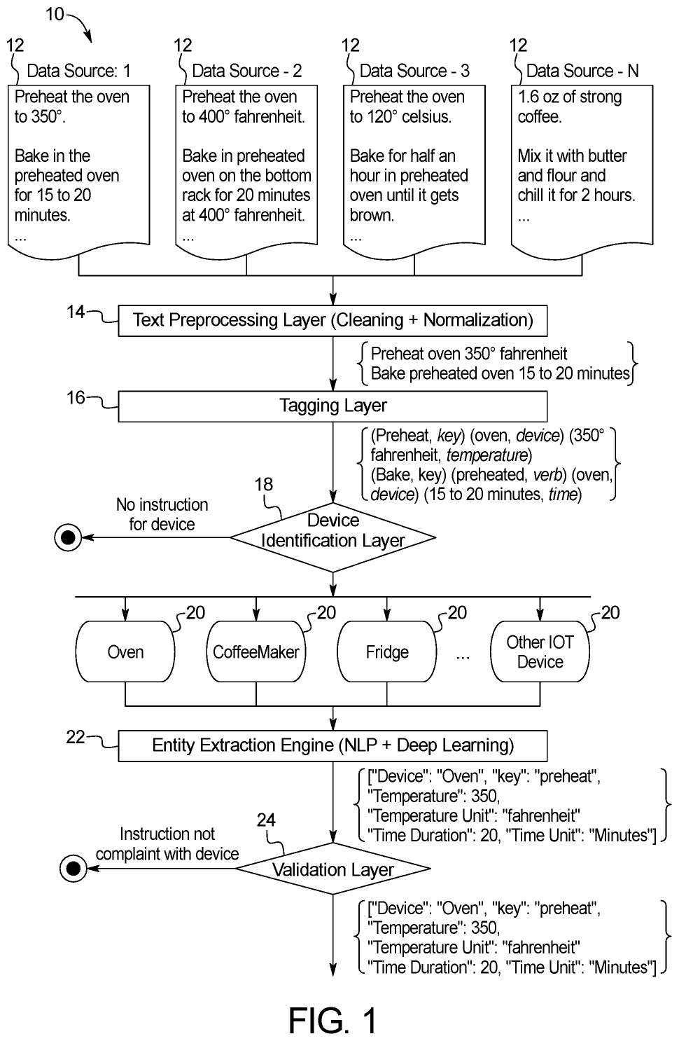

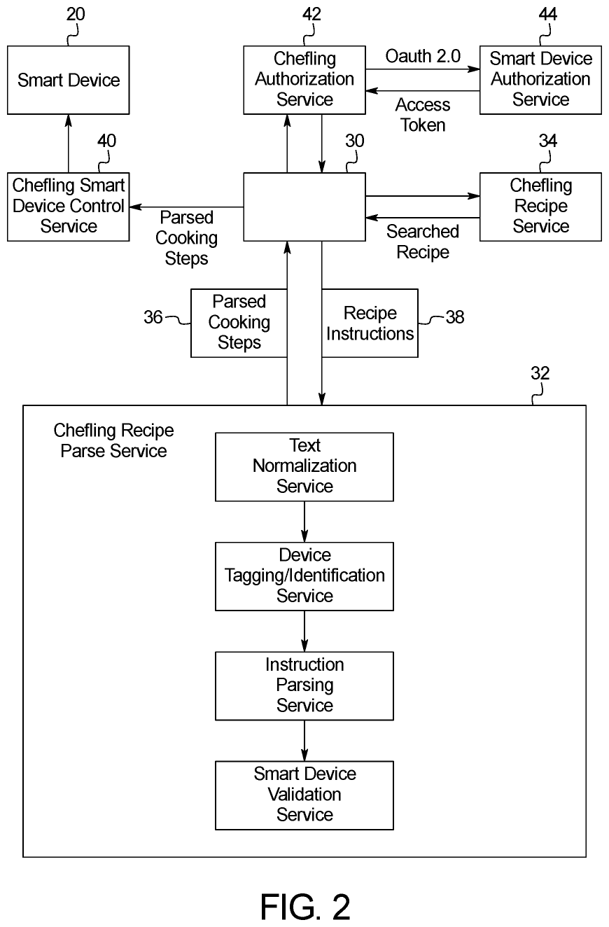

As shown in FIGS. 1-2, the system 10 can be supported by a controller 30 including at least one backend algorithm, wherein the controller 30 can include or communicate with a Recipe Parsing Service 32, which can receive the electronic recipes from a Recipe Service 34. The Recipe Server 24 can be any source of recipes, including manually typing in a recipe. In an example, the Recipe Server 24 can be a recipe website, blog, image of a recipe, among others. For example, the Recipe Server 24 can receive an image of a recipe from a user's mobile device (e.g., a photograph of the recipe from a cookbook, magazine, etc.), wherein the Recipe Parsing Service 32 can extract the relevant cooking and appliance information from the image.

The Recipe Parsing Service 32 can recognize and identify the recipe instructions 38 and appliances involved in the received recipe, including the parameters and settings. Given any well-structured recipe, the Recipe Parsing Service 32 extracts a series of cooking data steps 12 from the recipe 36, including each ingredient and cooking step, and sends the extracted data to a Text Pre-Process Layer 14. The Text Pre-Process Layer 14 can clean and normalize the received text, removing the irrelevant descriptions in the text, leaving only the appliance related text. The controller can send the cleaned text to a Tagging Layer 16, which tags the data with the appropriate appliance identifier, as well as the relevant setting parameters.

The controller 30 can extract the appliance name and settings are extracted and communicate the information to a Device Identification Layer 18, which confirms whether the appliance names are compliant with the appliances 20 that a user has connected in the system. If the extracted appliances are not compliant with any appliances that a user connected, then no further action can happen. If some of the extracted appliances are compliant with the appliances 20 a user has connected in the system, the appliance and instructions can be sent to a Deep Learning Engine 22, which can analyze the instructions, such as temperature change, timer information, etc. The Deep Learning Engine 22 can include an entity extraction engine using natural language processing. For example, the system can process the terms “oven”, “preheat”, “temperature”, “temperature unit”, “minutes”, among many others. The instructions and settings can be sent to the Validation Layer 24. If the instructions and settings are not compliant with the actual appliance 20, no further actions can happen. If the instructions and settings are compliant with the appliance 20, these instructions and settings can be sent to the control layer.

As shown in FIG. 2, the controller 30 can receive the parsed cooking steps from the Recipe Parsing Service 32 to the smart device control center 40 and/or directly to the smart appliance 20. The smart device control center can control a plurality of smart appliances 20. The Validation Layer 24 can include an Application Authentication Service 42 in communication with a Smart Device Authorization Service 44. The Application Authentication Service 42 can ensure the user is authorized to engage with the system. The Smart Device Authorization Service 44 can ensure the smart device and/or appliances are authorized to be controlled by the system. For example, a user can set up parameters that allow certain smart appliances for the system to control. If the user does not desire a certain smart appliance to engage with the system, for example the oven for fire safety, the user can deactivate the authorization of the smart oven for the system. Alternatively, or in addition to, the user can set up parameters that allow the system to engage with a smart appliance only for certain times and days. For example, the Smart Device Authorization Service 44 can check for authorization against the user parameters before engaging with the smart device. For example, if the user parameters only allow the system to engage with the smart oven during the evening hours during weekdays, then the system can check the time before engaging and controlling the oven without user action.

The system can include a user interface 100 that features a list of recipes. The list of recipes can come from the Recipe Server 24. The system 10 can suggest a narrowed list of recipes that can be made using the ingredients currently in the home. In an example, the system can automatically receive a user's food inventory from smart devices (e.g., smart refrigerator, pantry, etc.) For example, the system can include smart food storage (e.g., refrigerator, pantry, drawers) that can periodically, automatically update a user food inventory based on automatic periodic image acquisition of the food storage.

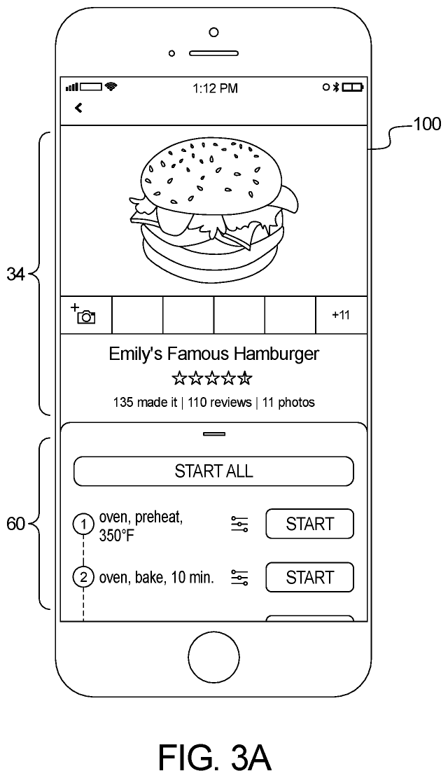

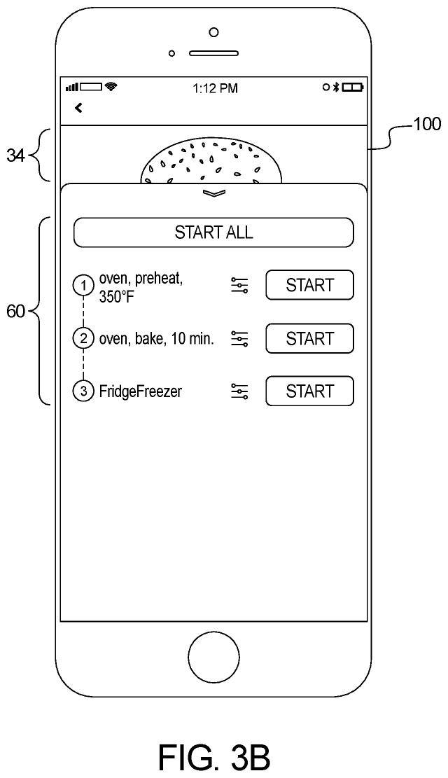

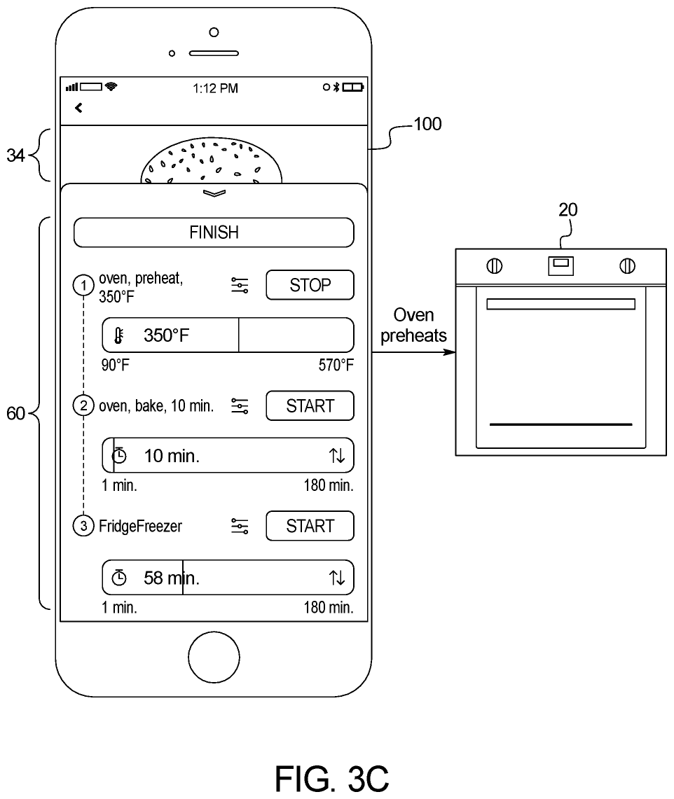

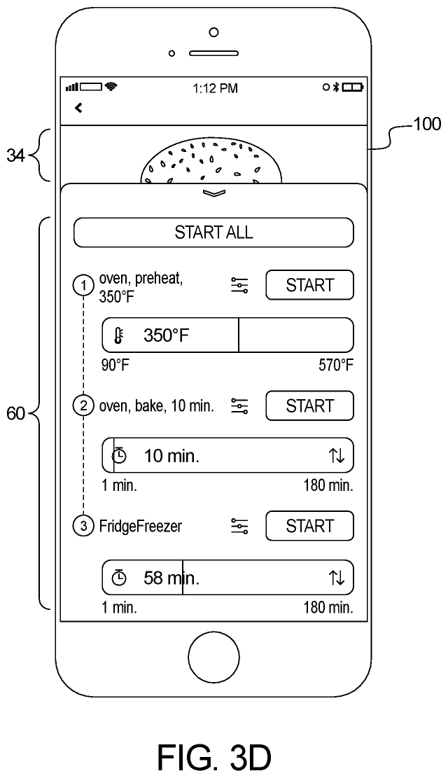

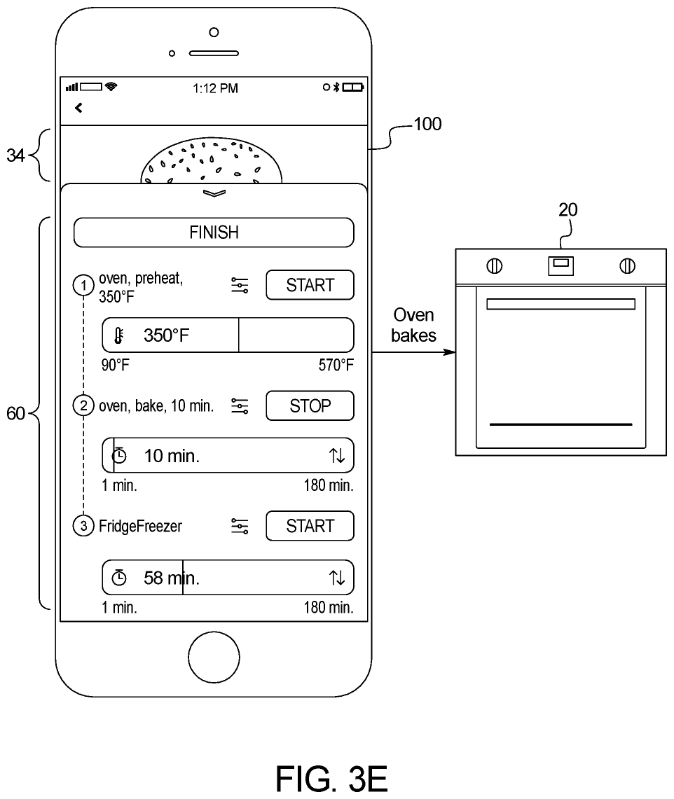

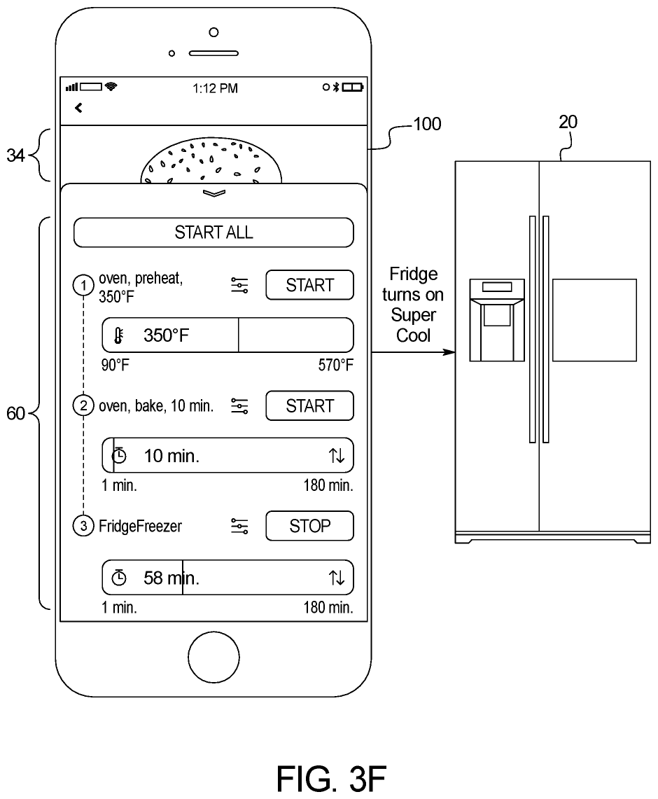

The user can select a recipe from the list of recipes for the system to receive and analyze. As shown in FIGS. 3A-3C, under the recipe screen of a recipe, a “drawer” style interface 60 can be displayed providing users information about all the appliances used in the recipe. Users can pull up the “drawer” style interface to view a list of appliances the detailed information of appliances, including appliance name, operation status, temperature, duration, etc. A benefit of the drawer configuration of the control center can contain all the appliances in one location.

A “Start” and/or “Send” button can be provided that, when selected (e.g., clicked), sends the instructions to the particular appliance to initiate the given parameters. The controller 30 receives the information received from the user via the user interface 60 and communicate the instructions to the smart devices 20. In an example, the user can press the “Send” button to communicate the instructions to the appliance for the settings, and the user can press start on the appliance itself to engage the appliance. Alternatively, the system can automatically send the instructions, wherein once the parameters are communicated to the appliance, the appliance can automatically start without the user's engagement with the appliance itself.

If the user would like to alter the appliance parameters before sending the “Start” instruction to the appliances, as shown in FIGS. 3D-3F, on the side of each appliance in the list, there can be actionable buttons displayed, wherein at least one of the buttons is for manual settings. Once a user clicks on the settings button, the parameter settings can show in the dropdown menu, allowing users to adjust the parameters such as temperature, time, duration, schedules, etc. After the adjustment to the parameters, upon the user's confirmation, the controller can send the instructions to the smart appliances.

The smart appliances in the present system are not limited to ovens and stoves, but includes coffee machines, bread machines, smart faucets, dishwashers, sauce dispenser, among others. For example, certain recipes require a specific amount of water, and the system can extract the water requirement for the recipe and deliver the exact amount of water for use in the recipe. Moreover, the system can control the temperature of the water via the water faucet including cold, lukewarm, hot, specific temperatures, still or sparkling water, among other specifications.

In another example, the system can control the dishwasher settings, wherein users can load the dishwasher and the system can control the timing and settings of the dishwasher to clean the dishware.

In yet another example, the system can include a smart coffee maker appliance, wherein the system can control the settings including temperature, heating mode, duration, time initiation, among others. The system can recognize the relevant ingredients (e.g., espresso, coffee, hot chocolate, tea) and the relevant quantity from the recipe or from user input parameters.

As mentioned above, aspects of the systems and methods described herein are controlled by one or more controllers. The one or more controllers may be adapted to run a variety of application programs, access and store data, including accessing and storing data in the associated databases, and enable one or more interactions as described herein. Typically, the controller is implemented by one or more programmable data processing devices. The hardware elements, operating systems, and programming languages of such devices are conventional in nature, and it is presumed that those skilled in the art are adequately familiar therewith.

For example, the one or more controllers may be a PC based implementation of a central control processing system utilizing a central processing unit (CPU), memory and an interconnect bus. The CPU may contain a single microprocessor, or it may contain a plurality of microprocessors for configuring the CPU as a multi-processor system. The memory may include a main memory, such as a dynamic random access memory (DRAM) and cache, as well as a read only memory, such as a PROM, EPROM, FLASH-EPROM, or the like. The system may also include any form of volatile or non-volatile memory. In operation, the memory stores at least portions of instructions for execution by the CPU and data for processing in accord with the executed instructions.

The one or more controllers may also include one or more input/output interfaces for communications with one or more processing systems. Although not shown, one or more such interfaces may enable communications via a network, e.g., to enable sending and receiving instructions electronically. The communication links may be wired or wireless.

The one or more controllers may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces for the controller. For example, the one or more controllers may include a graphics subsystem to drive the output mechanism. The links of the peripherals to the system may be wired connections or use wireless communications.

Although summarized above as a PC-type implementation, those skilled in the art will recognize that the one or more controllers also encompasses systems such as host computers, servers, workstations, network terminals, and the like. Further one or more controllers may be embodied in a device, such as a mobile electronic device, like a smartphone or tablet computer. In fact, the use of the term controller is intended to represent a broad category of components that are well known in the art.

Hence aspects of the systems and methods provided herein encompass hardware and software for controlling the relevant functions. Software may take the form of code or executable instructions for causing a controller or other programmable equipment to perform the relevant steps, where the code or instructions are carried by or otherwise embodied in a medium readable by the controller or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a controller can read programming code and/or data. Many of these forms of computer readable media may be involved in carrying one or more sequences of one or more instructions to a processor for execution.

It should be noted that various changes and modifications to the embodiments described herein will be apparent to those skilled in the art. Such changes and modifications may be made without departing from the spirit and scope of the present invention and without diminishing its attendant advantages. For example, various embodiments of the systems and methods may be provided based on various combinations of the features and functions from the subject matter provided herein.

We claim:

1. A system comprising:
a controller;
a memory coupled to the controller, wherein the memory is configured to store program instructions executable by the controller;
wherein in response to executing the program instructions, the controller is configured to:
receive a selected recipe from a user interface associated with a user;
extract at least one cooking appliance instruction from the selected recipe, wherein the cooking appliance instruction includes an appliance identifier and an appliance cooking parameter, wherein the appliance cooking parameter including a time duration parameter and a temperature parameter;
identify a cooking appliance corresponding to the appliance identifier, wherein the cooking appliance is in communication with the controller;
communicate the cooking appliance parameter to the cooking appliance corresponding to the appliance identifier, wherein the controller alters a temperature of the cooking appliance to match the temperature parameter for the time duration parameter; and
notify the user upon the cooking appliance achieving the appliance cooking parameter via the user interface.

2. The system of claim 1, wherein the controller receives the recipe from a Recipe Server, wherein the Recipe Server generates a list of recipes from at least one external website.

3. The system of claim 1, wherein the controller is configured to display a list of recipes on the user interface, wherein the selected recipe is selected from the list of recipes.

4. The system of claim 1, wherein the controller is configured to receive a user food inventory from at least one smart food storage device, and to generate a list of recipes based on the user food inventory, wherein the controller is configured to display a list of recipes on the user interface, wherein the selected recipe is selected from the list of recipes.

5. The system of claim 1, wherein the controller notifies the user via the user interface upon the cooking appliance achieving the temperature parameter.

6. The system of claim 1, wherein the controller notifies the user via the user interface upon the cooking appliance achieving the time duration parameter.
